(19) United States
(12) Patent Application Publication
(10) Pub. No.: US 2024/0395003 A1
(43) Pub. Date: Nov. 28, 2024

(54) INFORMATION PROCESSING APPARATUS, IMAGE PICKUP APPARATUS, INFORMATION PROCESSING METHOD, AND STORAGE MEDIUM

(71) Applicant: CANON KABUSHIKI KAISHA, Tokyo (JP)

(72) Inventors: NORIFUMI KASHIYAMA, Tokyo (JP); KAZUKI HOSOI, Tokyo (JP); TOKURO NISHIDA, Kanagawa (JP); HIROYUKI HASEGAWA, Chiba (JP); KOKI NAKAMURA, Tokyo (JP)

(21) Appl. No.: 18/627,603

(22) Filed: Apr. 5, 2024

(30) Foreign Application Priority Data
May 24, 2023 (JP) 2023-085676

(51) Int. Cl. G06V 10/25; G06F 3/14; G06T 3/40; G06T 7/62; H04N 23/61; H04N 23/67

(52) U.S. Cl. CPC G06V 10/25; G06F 3/14; G06T 3/40; G06T 7/62; H04N 23/61; H04N 23/675; G06V 2201/07

(57) ABSTRACT

An information processing apparatus includes a memory storing instructions, and a processor configured to execute the instructions to determine an object area that includes an object in a first image obtained by imaging of the object through an optical system and an image sensor, acquire, at a plurality of locations in the object area, first information that varies according to parallelism of the image sensor to the object, generate second information as a guide for a user adjusting the parallelism according to the first information, and output a second image including an image of the object area and the second information.

### BACKGROUND

### Technical Field

One of the aspects of the embodiments relates to an information processing apparatus configured to generate an image in which information as a user interface (UI) is superimposed on an image obtained by imaging.

### Description of Related Art

In inspection for maintenance of a structure such as a bridge or a tunnel, concrete cracking is detected by a method using artificial intelligence (AI). More specifically, cracking is detected by imaging of an inspection target using an image pickup apparatus such as a digital camera and by inputting an image obtained by the imaging to a cracking detection network subjected to deep learning. Cracking cannot be detected nor the length of cracking cannot be accurately detected without imaging while an image sensor in the image pickup apparatus properly or squarely faces the inspection target.

Japanese Patent Laid-Open No. 08-186757 discloses a camera configured to display, as a UI, facing state information (which may be referred to as parallelism information or parallelization information hereinafter) with which a user makes (an imaging surface of) an image sensor parallel to an object (surface) based on a distance measurement result to an object and to notify the user of a direction for correcting the tilt of the image sensor. Japanese Patent No. 6679779 discloses an image pickup apparatus configured to evaluate the parallelism of an image sensor to an area designated by a user in a captured image and control the tilt angle of the image sensor based on the evaluation result.

However, the image pickup apparatus disclosed in Japanese Patent Laid-Open No. 08-186757 displays the parallelism information about a non-object area in a case where an object is included in only part of the imaging angle of view. Accordingly, the parallelization accuracy of the image sensor to the object decreases. The image pickup apparatus disclosed in Japanese Patent No. 6679779 requires a user to manually set, for each imaging, an area in which the parallelism is to be evaluated, and thus imaging takes a long time.

### SUMMARY

An information processing apparatus according to one aspect of the disclosure includes a memory storing instructions, and a processor configured to execute the instructions to determine an object area that includes an object in a first image obtained by imaging of the object through an optical system and an image sensor, acquire, at a plurality of locations in the object area, first information that varies according to parallelism of the image sensor to the object, generate second information as a guide for a user adjusting the parallelism according to the first information, and output a second image including an image of the object area and the second information. An image pickup apparatus having the above information processing apparatus also constitutes another aspect of the disclosure. An image processing method corresponding to the above information processing apparatus and a storage medium storing a program that causes a computer to execute the above image processing method also constitute another aspect of the disclosure.

Further features of the disclosure will become apparent from the following description of embodiments with reference to the attached drawings.

### BRIEF DESCRIPTION OF THE DRAWINGS

FIG. 1 is a block diagram illustrating the configuration of an image pickup apparatus according to one embodiment.

FIGS. 2A and 2B illustrate part of a light-receiving surface of an image sensor.

FIG. 3 is a flowchart illustrating processing of calculating distance information according to the embodiment.

FIG. 4 illustrates correlation calculation.

FIG. 5 is another diagram illustrating correlation calculation.

FIG. 6 is a flowchart illustrating processing of displaying parallelism information during autofocus (AF) according to a first embodiment.

FIG. 7 is a flowchart illustrating processing of determining an object area according to the first embodiment.

FIG. 8 illustrates an example of highlighted display of the object area in the first embodiment.

FIG. 9 is a flowchart illustrating processing of determining a position of the parallelism information according to the first embodiment.

FIG. 10 explains the position of the parallelism information in the first embodiment.

FIGS. 11A, 11B, 11C, 11D, 11E, and 11F illustrate display examples of the parallelism information in the first embodiment.

FIG. 12 is a flowchart illustrating processing of displaying parallelism information at autofocusing in a second embodiment.

FIGS. 13A and 13B are a flowchart illustrating processing of performing sub window display according to a third embodiment.

FIG. 14 is a flowchart illustrating processing of determining a sub window display area in the third embodiment.

FIGS. 15A, 15B, 15C, 15D, and 15E illustrate examples of sub window display in third embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

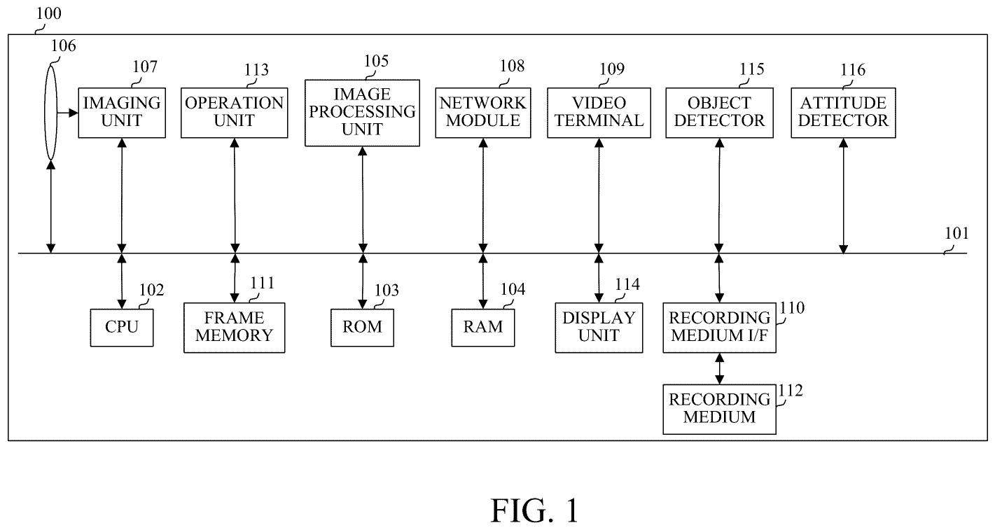

Embodiments of the present disclosure will be described below with reference to the accompanying drawings. A description will now be given of an image pickup apparatus (digital camera) including an information processing apparatus that executes processing in first to third embodiments to be described below. FIG. 1 illustrates the configuration of an image pickup apparatus 100. The image pickup apparatus 100 performs image acquisition by imaging, image processing, and image recording.

An internal bus 101 connects a CPU 102, a ROM 103, a RAM 104, an image processing unit 105, a lens unit 106, an imaging unit 107, a network module 108, a video terminal 109, a recording medium I/F 110, a display unit 114, and an object detector 115. The components connected to the internal bus 101 can communicate data with one another through the internal bus 101.

The lens unit 106 includes an optical system including a zoom lens, a focus lens, and an aperture mechanism, and a motor configured to drive the optical system. An optical image formed through the lens unit 106 is converted (in other words, captured) into an imaging signal that is an analog electric signal by an image sensor such as a CCD sensor or a CMOS sensor, which is included in the imaging unit 107. The imaging unit 107 also includes an A/D converter configured to convert an imaging signal output from the image sensor into a digital signal (image data). The image sensor is an imaging-surface phase-difference sensor and will be described in detail below.

The CPU 102 as a computer operates by using the RAM 104 as a work memory according to a computer program stored in the ROM 103 and accordingly controls each component of the image pickup apparatus 100.

The ROM 103 is a non-transitory memory and records the computer program for operating the CPU 102 and various parameters and the like. The RAM 104 is a transitory memory. A frame memory 111 is a memory that temporarily stores image data and from which image data can be read as necessary. The frame memory 111 can be used to perform processing, for example, of combining images obtained by imaging at timings different from each other or cutting a particular area out of an image obtained by imaging.

The image processing unit 105 as an information processing apparatus performs, under control of the CPU 102, various kinds of image processing for image data from the imaging unit 107 or image data stored in the frame memory 111 or a recording medium 112. The image processing performed by the image processing unit 105 includes pixel interpolation, encoding processing, compression processing, decode processing, scaling up-down (resize) processing, noise reduction processing, and color conversion processing of image data. In addition, the image processing unit 105 corrects performance variance among a plurality of pixels of the image sensor, corrects defect pixels, corrects white balance, corrects luminance, and corrects distortion and ambient light reduction that occur due to lens characteristics. Moreover, the image processing unit 105 performs processing of generating distance information to be described below. The image processing unit 105 may be configured as a dedicated image processing computer configured to perform image processing, and the CPU 102 may have functions of the image processing unit 105.

The CPU 102 performs optical zoom, focusing, and aperture adjustment by controlling each motor of the lens unit 106 based on a lens control calculation result obtained from the image processing unit 105. The CPU 102 may additionally perform image stabilization by moving any lens as part of the optical system in a direction orthogonal to an optical axis according to a camera shake detected by an attitude detector 116 to be described below.

An operation unit 113 receives an operation by a user and outputs an instruction corresponding to the operation to the CPU 102 or the image processing unit 105. The operation unit 113 includes operation members such as a switch, a dial, and a button. The operation members include a power switch, a mode switching dial, and a release button. When half-pressed by the user, the release button instructs the CPU 102 to start an imaging preparation operation such as autofocus (AF) and auto-exposure control (AE). When fully pressed by the user, the release button instructs the CPU 102 to start an imaging operation to acquire image data for recording. The operation unit 113 may be a touch sensor provided at the display unit 114.

The display unit 114 as a display unit displays an image processed by the image processing unit 105, a setting menu, and the like. The display unit 114 includes a display device such as a liquid crystal display (LCD) and an organic electroluminescence (EL). The display unit 114 may be provided with the above touch sensor.

The CPU 102 generates text information and icons for notifying the user of a setting state and the like of the image pickup apparatus 100 and an image of a setting menu for performing various settings of the image pickup apparatus 100, superimposes them on an image processed by the image processing unit 105, and displays the image on the display unit 114.

The video terminal 109 is a terminal for video interface such as serial digital interface (SDI), High Definition Multimedia Interface (HDMI) (registered trademark), or DisplayPort (registered trademark). The CPU 102 can output videos (image data) to an external monitor or the like through the video terminal 109.

The network module 108 is an interface for inputting and outputting image data and voice signals. The CPU 102 can communicate with an external instrument through the network module 108 and through the Internet or the like and transmit and receive not only image data and voice signals but also control signals such as commands. The network module 108 may be of a wireless communication type or a wired communication type.

The recording medium 112 is a hard disk drive (HDD), a solid-state drive (SSD), or the like capable of recording image data and various kinds of setting data and detachably mounted on the recording medium I/F 110.

The object detector 115 detects an object using artificial intelligence such as deep learning using a neural network. In object detection by deep learning, the CPU 102 transmits a computer program, a network structure, a weight parameter, and the like stored in the ROM 103 to the object detector 115. The network structure is of a Single Shot Multibox Detector (SSD), You Only Look Once (YOLO), or the like. The object detector 115 performs processing of detecting an object from image data based on various parameters obtained from the CPU 102 and transfers a result of the processing to the RAM 104.

The attitude detector 116 detects the posture of the image pickup apparatus 100 and its shake by using an angular velocity sensor, an acceleration sensor, or the like. Thereby, the tilt of the image pickup apparatus 100 and camera shake thereof due to manual shake can be detected.

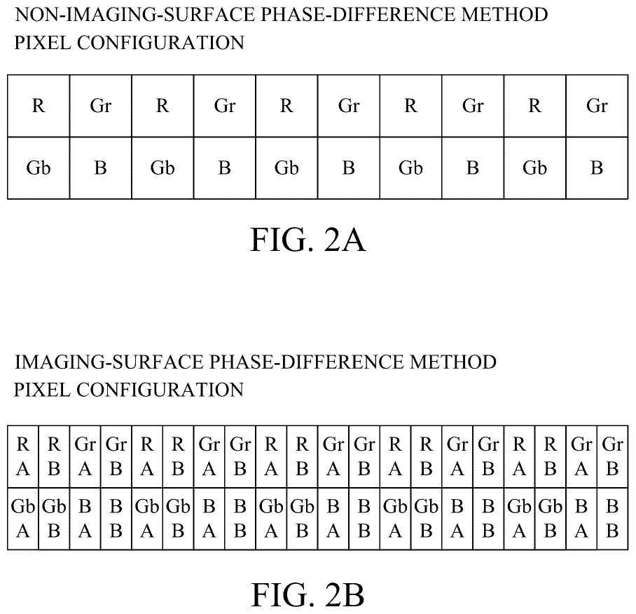

FIG. 2A schematically illustrates part of the image sensor including Bayer-arrayed pixels of red (R), blue (B), and green (Gb, Gr). As illustrated in FIG. 2B, each pixel includes two photodiodes A and B as photoelectric conversion elements, and the two photodiodes A and B share an unillustrated single microlens. Due to this configuration, the two photodiodes A and B receive light from two areas different from each other in an exit pupil of the lens unit 106 and output A signal and B signal. The imaging unit 107 generates a pair of image signals (A and B image signals) for phase difference detection by combining the A and B signals output from each of the plurality of pixels on the image sensor. In addition, the A and B image signals are added to generate an imaging signal for obtaining image data.

In addition to outputting the A and B signals from each pixel, the imaging unit 107 may output a value obtained by averaging the A and B signals from each of a plurality of pixels close to one another. Outputting of the averaged value can reduce time for reading signals from the imaging unit 107 and the band of the internal bus 101.

The CPU 102 performs correlation calculation of a pair of image signals, calculates a phase difference thereof, and calculates information about a defocus amount based on the phase difference. The defocus amount indicates the defocus degree relative to an in-focus state of the lens unit 106. The CPU 102 determines that the state is an in-focus state in a case where the defocus amount is in a predetermined range including zero, or determines that the state is a front focus state or a rear focus state in a case where the defocus amount is positive or negative, respectively. The CPU 102 performs imaging-surface phase-difference AF by controlling a motor that drives the focus lens of the lens unit 106 according to the defocus amount that is positive or negative. The CPU 102 also calculates the reliability of the calculated phase difference. In addition, the CPU 102 calculates a distance to an object by using the principle of triangulation based on a parallax between the pair of image signals and optical information about the lens unit 106.

Although FIG. 2B illustrates a case where each pixel is provided with two photodiodes, the number of photodiodes in each pixel may be equal to or larger than three. A plurality of pixels opened at different positions from one another may be provided at the image sensor and treated as one pixel in focus detection. In this manner, the image sensor only needs to have a configuration with which a pair of image signals for phase difference detection can be obtained.

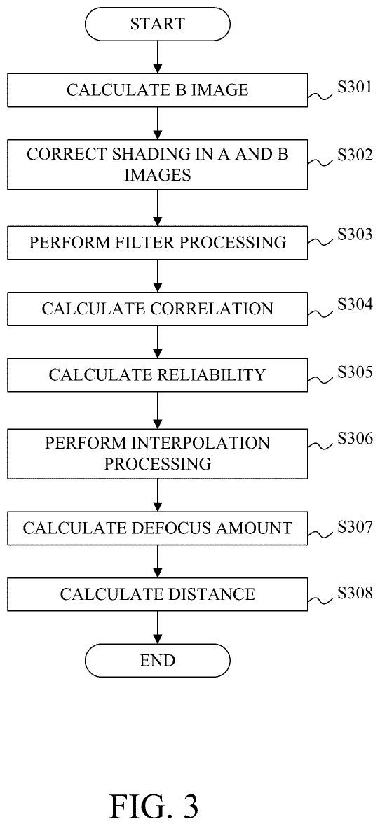

Referring now to FIGS. 3 to 5, a description will be given of information generation processing performed at the image processing unit 105. The image processing unit 105 functions as a determining unit, a generator, and a control unit.

The flowchart of FIG. 3 illustrates distance calculation processing executed by the image processing unit 105 according to a computer program upon the start of imaging at the imaging unit 107. First at step S301, the image processing unit 105 calculates (acquires) the B image signal by calculating a difference between the imaging signal (A image signal+B image signal) output from the imaging unit 107 and the A image signal. At this step, the A and B image signals may be each acquired from the imaging unit 107. In this case, a signal obtained by adding the A and B image signals is acquired as the imaging signal. In a case where two lens units and two image sensors are included as in a stereo camera, the A image signal may be acquired from one of the two image sensors and the B image signal may be acquired from the other.

Next at step S302, the image processing unit 105 corrects shading caused by optical factors for the A and B image signals.

Next at step S303, the image processing unit 105 performs filter processing for each of the A and B image signals. The filter processing is, for example, high-pass filter processing using a finite impulse response (FIR) filter. The following description will be made for a case of using the A and B image signals on which the high-pass filter processing is performed, but filter processing using a band-pass filter with a different filter coefficient or a low-pass filter may be performed.

Next at step S304, the image processing unit 105 divides each of the A and B image signals for which the filter processing is performed at step S303 into minute blocks, and calculates correlation for each divided block. The size and shape of each minute block are not particularly limited, and parts of nearby blocks may overlap each other.

A description will be now given of the correlation calculation of the A and B image signals. A signal sequence of the A image signal at a target pixel will be referred to as an A image signal sequence E(1) to E(m), and a signal sequence of the B image signal at the target pixel will be referred to as a B image signal sequence F(1) to F(m). While the B image signal sequence F(1) to F(m) is shifted relative to the A image signal sequence E(1) to E(m), a correlation amount C(k) for a shift amount k between the pair of image signal sequences is calculated by using Equation (1) below.

$$C ( k ) = \sum \vert E ( n ) - F ( n + k ) \vert \qquad ( 1 )$$

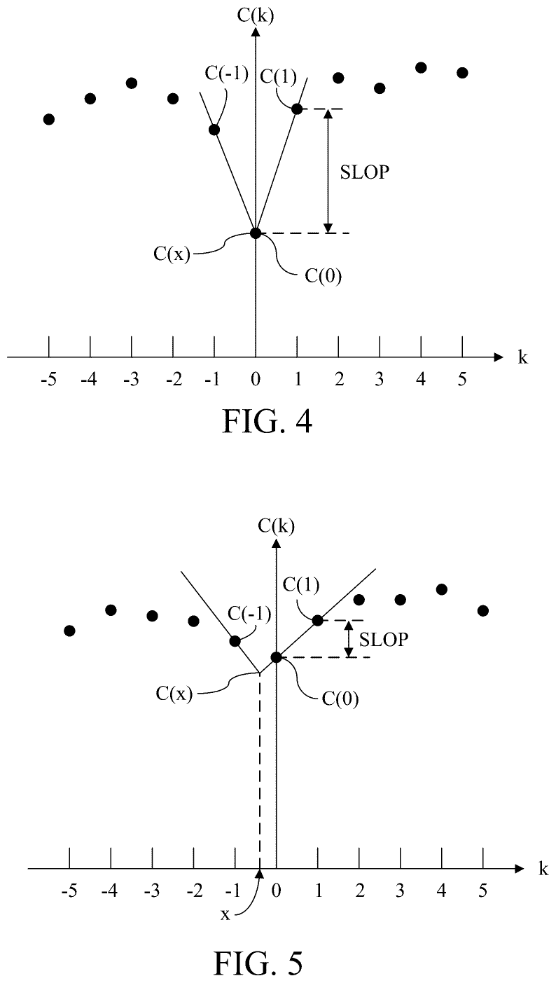

In Equation (1), the Σ calculation means calculation of the sum for n. In the Σ calculation, the range of n and n+k is limited to the range of 1 to m. The shift amount k has an integer value and is a relative pixel shift amount in the unit of a detection pitch (pixel array pitch) of the pair of image signal sequences. FIG. 4 illustrates a calculation result of Equation (1) in a case where correlation between the pair of image signal sequences is high in an ideal state in which no noise exists.

As illustrated in FIG. 4, the correlation amount C(k) is minimum at the shift amount (k=kj=0) with which the correlation between the pair of image signal sequences is high. The shift amount k when the correlation amount C(k) that is discrete is minimum will be referred to as kj. Apixel shift amount (phase difference) x that provides a minimum value C(x) for the correlation amount that is continuous is calculated by three-point interpolation processing indicated in Equations (2) to (4). The pixel shift amount x is a real number and has the unit of “pixel”.

$$x = kj + \frac{D}{S L O P} \qquad ( 2 )$$

$$D = \frac{\{ C ( k j - 1 ) - C ( k j + 1 ) \}}{2} \qquad ( 3 )$$

$$SLOP = MAX \{ C ( k j + 1 ) - C ( k j ) , C ( k j - 1 ) - C ( k j ) \} \qquad ( 4 )$$

In Equation (4), SLOP represents a gradient of change in either of a correlation amount that is minimum and locally minimum and a correlation amount adjacent to it. In FIG. 4, specific examples are:

$$\begin{matrix}C ( kj ) = C ( 0 ) = 1 \; 000 \\ C ( kj - 1 ) = C ( - 1 ) = 1700 \\ C ( kj + 1 ) = C ( 1 ) = 1830 .\end{matrix}$$

In this example, kj is zero. From Equations (2) to (4),

SLOP=830

x=−0.078 pixel

are obtained. In the in-focus state, the pixel shift amount x between the pair of image signal sequences has an ideal value of 0.00.

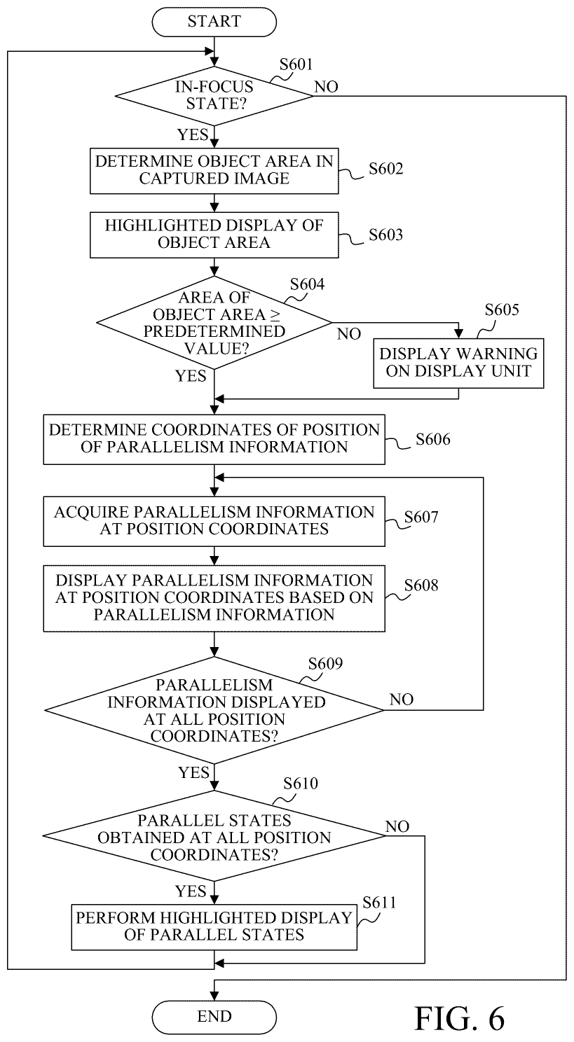

FIG. 5 illustrates a calculation result when Equation (1) is applied to a minute block in which noise exists. As illustrated in FIG. 5, the correlation between the pair of image signal sequences decreases due to influence of noise distributed at random.

The minimum value of the correlation amount C(k) is larger than the minimum value illustrated in FIG. 4, and the curve of the correlation amount is flat as a whole (the absolute value of the difference between maximum and minimum values decreases).

In FIG. 5, specific examples are:

$$\begin{matrix}C ( kj ) = C ( 0 ) = 1300 \\ C ( kj - 1 ) = C ( - 1 ) = 1480 \\ C ( kj + 1 ) = C ( 1 ) = 1800\end{matrix}$$

In this example, kj is zero. From Equations (2) to (4),

SLOP=500

x=−0.32 pixel

are obtained.

The pixel shift amount x is farther away from the ideal value than the calculation result in the state illustrated in FIG. 4 in which no noise exists.

In a case where the correlation between the pair of image signal sequences is low, a change amount of the correlation amount C(k) decreases and a correlation amount curve becomes flat as a whole, and accordingly, the value of SLOP decreases. Similarly, in a case where an object image has a low contrast, as well, the correlation between the pair of image signal sequences decreases and a correlation amount curve becomes flat. Based on this characteristic, the reliability of the calculated pixel shift amount x can be determined based on the value of SLOP. More specifically, it can be determined that the correlation between the pair of image signal sequences is high in a case where the value of SLOP is large, and significant correlation is not obtained between the pair of image signal sequences in a case where the value of SLOP is small. In this embodiment, since Equation (1) is used for the correlation calculation, the correlation amount C(k) is minimum and locally minimum at the shift amount k with which the correlation between the pair of image signal sequences is highest. In another correlation calculation method, the correlation amount C(k) may be maximum and locally maximum at the shift amount k with which the correlation between the pair of image signal sequences is highest.

Next at step S305, the image processing unit 105 calculates the reliability of the calculated pixel shift amount x. The reliability can be defined by using C(kj) and the value of SLOP, which indicate the degree to which the pair of image signals calculated at step S304 match each other.

Next at step S306, the image processing unit 105 performs interpolation processing. The pixel shift amount x of the target pixel cannot be employed in some cases because the reliability calculated at step S305 is low although the correlation calculation is performed at step S304. In such a case, the pixel shift amount of the target pixel needs to be acquired by interpolation using pixel shift amounts calculated at pixels adjacent to the target pixel. The interpolation may be performed by a method of applying a median filter to the pixel shift amounts calculated at the adjacent pixels or by a method of scaling down data of the pixel shift amounts and then scaling up the data again. Alternatively, color data may be extracted from the imaging signals and used to interpolate the pixel shift amount.

Next at step S307, the image processing unit 105 calculates a defocus amount by referring to the pixel shift amount x calculated at step S304 or acquired by the interpolation at step S306. A defocus amount (DEF) can be calculated by Equation (5) below:

$$DEF = P \cdot x \qquad ( 5 )$$

In Equation (5), P is a conversion coefficient determined by the detection pitch and the distance between projected centers of two viewpoints in the pair of parallax images (A and B image signals) (the distance between the center of gravity of an image sensor that generates the A image signal and the center of gravity of an image sensor that generates the B image signal). The unit of the conversion coefficient is mm/pixel.

Next at step S308, the image processing unit 105 calculates a distance based on the defocus amount calculated at step S307. Equation (6) below is approximately established:

$$\frac{1}{D b} - \frac{1}{D a} = \frac{1}{F} \qquad ( 6 )$$

where Da is a distance to an object, Db is a focal position of the lens unit 106, and F is a focal length.

The distance Da to the object is expressed as follows:

$$D a = \frac{Db \cdot F}{F - D b} \qquad ( 7 )$$

From Equation (7), the following equation can be obtained:

$${Da}^{′} = \frac{( D b 0 - D EF ) \cdot F}{F - ( D b 0 - D E F )} \qquad ( 8 )$$

where Db0 is Db at DEF=0, and an absolute distance Da′ to the object can be obtained. The relative distance of Da−Da′ can be calculated from Equations (7) and (8) as follows:

$$Da - {Da}^{′} = \frac{DEF \cdot {F}^{2}}{{( F - D b 0 )}^{2} + DEF \cdot ( F - D b 0 )} \qquad ( 9 )$$

Through the above processing illustrated in FIG. 3, the pixel shift amount, the defocus amount, and the distance to the object can be acquired based on the A and B image signals.

Information regarding the focus state of the optical system (such as the pixel shift amount and the defocus amount) or information regarding the distance from the image sensor to the object (such as the above relative distance), which is thus acquired as first information at a plurality of locations on the object in first to third embodiments below. The first information acquired at a plurality of locations changes according to the parallelism of the imaging unit (imaging surface of the image sensor) 107 to the object (object surface). The first information is used to generate parallelism information as second information to be described below. In the following description, the information regarding the distance from the image sensor to the object will be referred to as distance information. The information regarding the focus state and the distance is not limited to information that directly indicates the focus state and the distance but may be information that can be converted into or is associated with the focus state and the distance.

### First Embodiment

A description will now be given of parallelism information display processing executed by the image pickup apparatus 100 (the CPU 102 and the image processing unit 105) during servo AF and continuous AF according to a first embodiment. The servo AF is a function to repeat AF while the release button is half-pressed by the user. The continuous AF is a function to constantly repeat AF irrespective of an operation of the release button.

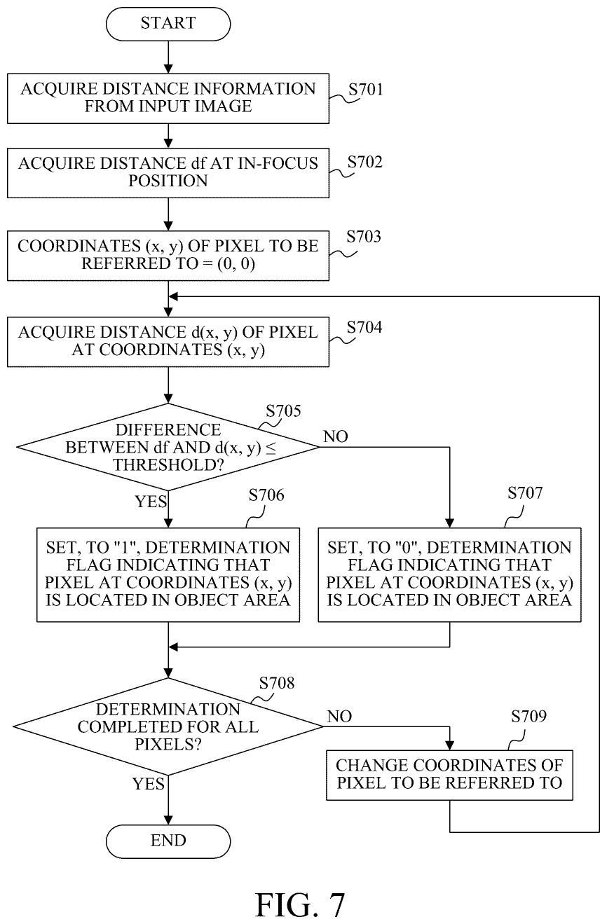

A flowchart of FIG. 6 illustrates processing of performing superimposition display of the parallelism information on an input image (first image) that is acquired through imaging performed by the image pickup apparatus 100 and is displayed on the display unit 114. The parallelism information will be described below. The CPU 102 and the image processing unit 105 execute this processing according to a computer program. This processing is executed when a servo AF mode or a continuous AF mode is set as an AF mode through a setting menu by the user and imaging is started by the imaging unit 107.

First at step S601, the CPU 102 determines whether the lens unit 106 is in an in-focus state in a predetermined AF area of an imaging range (entire image sensor). In a case where the lens unit 106 is in the in-focus state, processing at step S602 is performed. In a case where the lens unit 106 is not in the in-focus state, this processing is ended. The AF area may be set by the CPU 102 or the user.

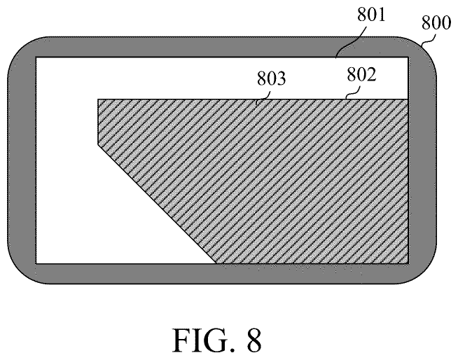

Next at step S602, the image processing unit 105 determines an object area that includes an object in a captured image generated by imaging. The object area determination will be described below with reference to a flowchart of FIG. 7.

At step S701, the image processing unit 105 determines the object area included in an input image. A captured image is input to the image processing unit 105 in a raster direction with an origin at an upper left pixel. In this embodiment, the object area is determined by using the distance information in an effective image area of the captured image input to the image processing unit 105. The effective image area is an area of signals (images) output from the image sensors of effective pixels in the captured image. However, an image area in which the object area is determined may be different in size from the effective image area. For example, in a case where an image area obtained by cutting out part of the effective image area is to be displayed in an enlarged manner on the display unit 114, the object area may be determined in a cut-out image area. In the following description, the image area in which the object area is determined will be referred to as a determination image area.

The distance information is acquired by the processing illustrated in FIG. 3 while a direction departing from the imaging unit 107 is set positive. The distance information is not limited to acquisition by the processing illustrated in FIG. 3 but may be acquired by using a distance measuring apparatus configured to measure the distance to the object and provided separately from the image sensor in the image pickup apparatus 100. The distance measuring apparatus is, for example, a radar or Light Detection and Ranging (LiDAR).

Next at step S702, the image processing unit 105 acquires, based on the distance information acquired at step S701, a distance df to the object (in-focus position) on which the lens unit 106 is in the in-focus state, and stores the distance df in the RAM 104.

Next at step S703, the image processing unit 105 initializes, to (0, 0), the coordinates (x, y) of a pixel the distance information about which is to be referred. More specifically, the coordinates of the upper left pixel of the determination image area are initialized to (0, 0). In the coordinates (x, y), x indicates a coordinate of the determination image area in the horizontal direction, and y indicates a coordinate of the determination image area in the vertical direction.

Next at step S704, the image processing unit 105 acquires a distance d(x, y) of the pixel at the coordinates (x, y).

Next at step S705, the image processing unit 105 calculates a difference between the distance df to the in-focus position and the distance d(x, y) of the pixel at the coordinates (x, y) and determines whether the difference is equal to or smaller than a threshold. In a case where the difference is equal to or smaller than the threshold, processing at step S706 is performed. In a case where the difference is larger than the threshold, processing at step S707 is performed. Since the distance is defined as positive in the direction departing from the imaging unit 107 as described above, the above-described difference is negative when the distance d(x, y) is closer to the imaging unit 107 than the in-focus position. The above difference is positive when the distance d(x, y) is farther from the imaging unit 107 than the in-focus position. The threshold is a value for the object area determination. Since the distance difference can be positive and negative, two thresholds that are positive and negative are prepared. The absolute values of the two thresholds may be equal to each other or different from each other. The thresholds may be set as fixed values in advance or may be optionally set by a user operation through a setting menu.

At step S706, the image processing unit 105 determines that the pixel at the coordinates (x, y) is in the object area, and sets a determination flag (hereinafter referred to as an in-object area flag) to “1”. The determination flag indicates that the pixel is in the object area.

At step S707, the image processing unit 105 determines that the pixel at the coordinates (x, y) is out of the object area, and sets the in-object area flag of the pixel to “0”. In this embodiment, whether the pixel is in the object area is indicated by whether the in-object area flag is “1” or “0”, but values other than “1” and “0” may be used to express whether the pixel is in the object area, or an out-of-object area flag may be separately provided in addition to the in-object area flag.

Next at step S708, the image processing unit 105 determines whether the determination of whether a pixel is in the object area has been completed for all pixels in the determination image area. In a case where the determination has been completed, this processing is ended. In a case where the determination has not yet completed, processing at step S709 is performed.

At step S709, the image processing unit 105 changes the coordinates of a pixel the distance information about which is to be referred. Then, the flow returns to step S704. More specifically, in a case where a pixel at the coordinates (x+1, y) exists as a pixel for which determination of whether the pixel is in the object area has not yet been completed, the determination is performed for the pixel at the coordinates (x+1, y). In a case where the pixel at the coordinates (x+1, y) does not exist but a pixel at the coordinates (0, y+1) exists, the above determination is performed for the pixel at the coordinates (0, y+1). In a case where the pixel at the coordinates (x+1, y) does not exist or the pixel at the coordinates (0, y+1) does not exist, the above determination has been completed up to the lower right pixel of the determination image area and thus the object area determination processing is ended.

Through the above processing, the object area can be determined based on the input image. The object area determination is not limited to this method, and an area in which the above-described pixel shift amount is equal to or smaller than a threshold may be determined as the object area. Alternatively, an edge extraction filter may be applied to the input image to extract the outline of the object area, and an area in which pixels at equal distance are continuous may be set as the object area. The input image may be input to a neural network such as a fully convolutional network, and an image area in which an image of a particular object is recognized may be set as the object area. A plurality of methods of object area determination may be combined.

Processing using the above determination flag for the object area is continued in this embodiment, but an object area map in which the determination flag is associated with each pixel of a captured image may be produced and temporarily stored in the frame memory 111 and the RAM 104.

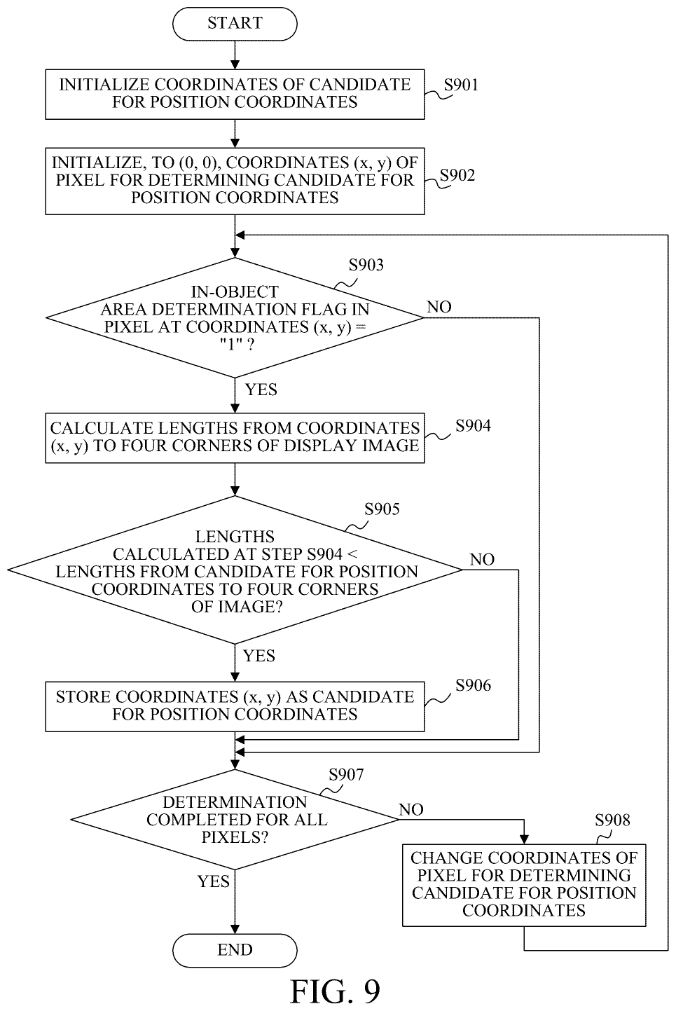

Next at step S603, the image processing unit 105 causes the display unit 114 to perform highlighted display of the object area determined by the image processing unit 105 at step S602. In the highlighted display, as illustrated in FIG. 8, for example, a highlighted image 803 such as a hatching pattern that highlights an object area 802 is superimposed on a (display) image 801 corresponding to the captured image or the determination image area and displayed on a display unit 800 (114). The image 801 may be a partial image area that is cut out of the captured image or the determination image area. The highlighted image may be a frame line surrounding the object area, or an image that colors the object area. An image that colors an object area may have transparency.

Next at step S604, the image processing unit 105 determines whether the area of the object area is equal to or larger than a predetermined value (predetermined value). In a case where the area is equal to or larger than the predetermined value, processing at step S606 is performed. In a case where the area is smaller than the predetermined value, processing at step S605 is performed. The area of the object area can be calculated, for example, by measuring the number of pixels included in the object area. The predetermined value may be set in advance through a menu operation by the user or may be set as a preset value of the CPU 102. The area of the object area equal to or larger than the predetermined value can maintain the parallelization determining accuracy because the area is large enough.

At step S605, the image processing unit 105 performs warning display on the display unit 114. The warning display warns the user that the object area is small, and prompts him to reset the object area. As the warning display method, a message that the object area is small may be superimposed on the image 801 and displayed on the display unit 114. The hatching pattern displayed at step S603 may be flashed or colored differently from the color of the highlighted display.

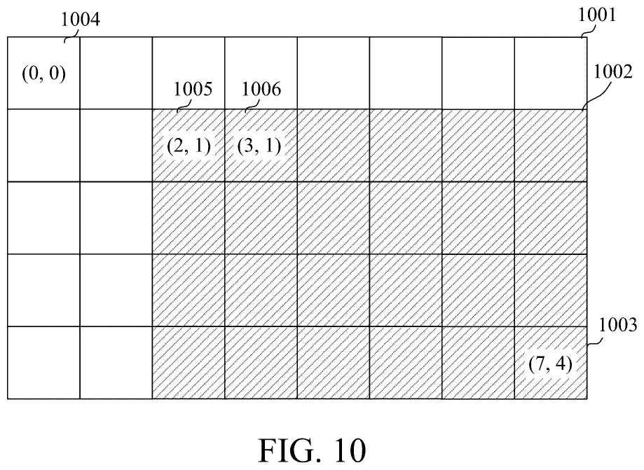

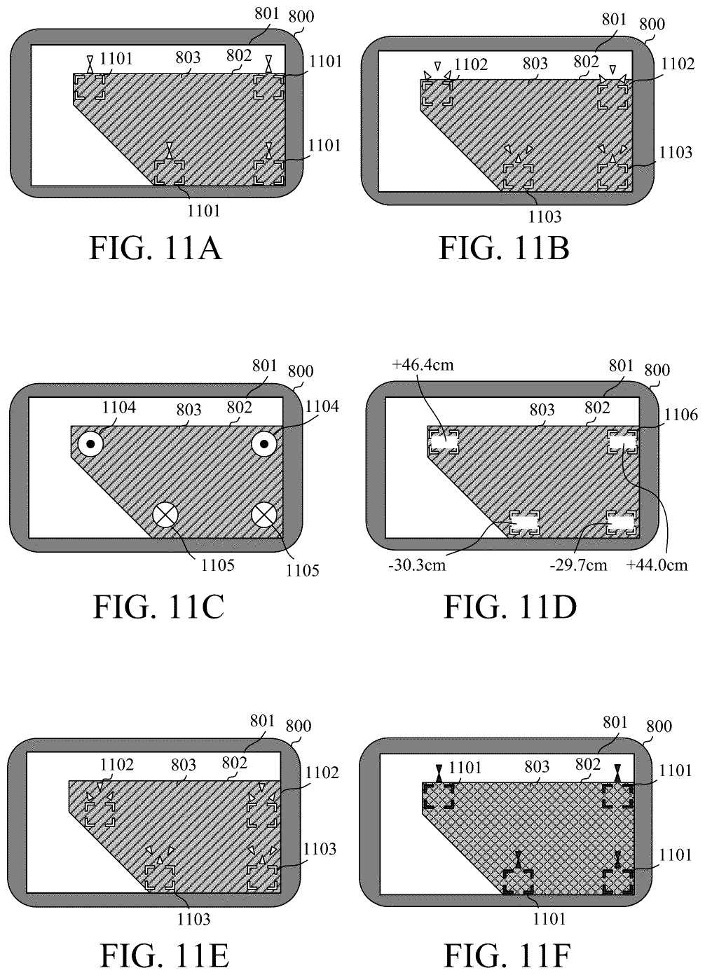

At step S606, the image processing unit 105 determines coordinates of the position of the parallelism information (which may be referred to as position coordinates). Referring now to FIGS. 9 and 10, a description will be given of a method of determining the position coordinates. A flowchart illustrated in FIG. 9 illustrates processing of determining the position coordinates, which is executed by the image processing unit 105.

At step S901, the image processing unit 105 initializes the coordinates of candidates for the position coordinates. The position coordinates include coordinates of a pixel from which distance information for the parallelism information is acquired by processing to be described below, and coordinates that are used to determine display positions of parallelism display markers as the parallelism information. This embodiment uses four candidates for the position coordinates to acquire the coordinates of the upper left position, upper right position, lower left position, and lower right position in the object area. The candidates for the position coordinates are stored in the RAM 104, and the coordinates of pixels located at the positions of four opposing corners of an image are initialized as initial values. The number of candidates for the position coordinates and the initial values are not limited to this embodiment.

Next at step S902, the image processing unit 105 initializes, to the origin (0, 0), the coordinates (x, y) of pixels for determining the candidates for the position coordinates.

Next at step S903, the image processing unit 105 determines whether the determination flag in the object area for the pixel at the coordinates (x, y) is “1”. In a case where the determination flag is “1”, processing at step S904 is performed. In a case where the determination flag is “0”, processing at step S907 is performed.

Next at step S904, the image processing unit 105 calculates a lengths from the coordinates (x, y) to each of pixels at the four, upper left position, upper right position, lower left position, and lower right position in the object area in the determination image area for which the object area is determined at step S602. The length, as used herein, means a distance between two points on a two-dimensional plane in a case where an image is handled as the plane, and is calculated by using the Pythagorean theorem. The length is not limited to this method but may be the sum of a length in the horizontal direction and a length in the vertical direction.

Next at step S905, the image processing unit 105 determines whether the lengths calculated at step S904 are shorter than the lengths from the candidates for the position coordinates to the pixels at the above four corners. Processing at the present step will be described below. The image processing unit 105 performs processing at step S906 in a case where the lengths calculated at step S904 are shorter, or performs processing at step S708 otherwise.

At step S906, the image processing unit 105 stores the coordinates (x, y) as a new candidate for the position coordinates.

At step S907, the image processing unit 105 checks whether the candidate for the position coordinates has been determined for all pixels of the object area. This processing is ended in a case where the determination has been completed for all pixels, or processing at step S908 is performed in a case where there is an undetermined pixel.

At step S908, the image processing unit 105 changes the coordinates of a pixel referred to for determining the candidate for the position coordinates. After the coordinates are changed, the flow returns to step S903 and repeats the determination of the candidates for the position coordinates. Finally, a plurality of coordinates stored as candidates for the position coordinates when processing is ended in the entire object area are used as the final coordinates of the position of the parallelism information, and used for the subsequent processing.

Referring now to FIG. 10, a description will be given of a method of determining the coordinates of the position of the parallelism information by calculating and comparing the lengths from the candidates for the position coordinates to the four corners of the determination image area. This embodiment disposes the parallelism information to be described below at four positions including the upper left corner, the upper right corner, the lower left corner, and the lower right corner in the object area, and thus determines four (a plurality of) candidates for the position coordinates. FIG. 10 illustrates, as an example, a method of determining the coordinates of the position of the parallelism information at the upper left corner by acquiring and comparing the length from the candidate for the position coordinates to an upper left pixel 1004 in a determination image area 1001. Pixels in the determination image area are input in the raster direction and an origin is set to the upper left pixel in the determination image area.

In FIG. 10, to first determine a candidate for the position coordinates at the upper left corner in an object area 1002 in the determination image area 1001, coordinates (7, 4) of a lower right pixel 1003 positioned at the opposing corner to the upper left corner is acquired and stored in the RAM 104 as an initial value of the candidate for the position coordinates. Next, whether the pixel 1004 is in the object area is determined by using the flag in the object area for the pixel 1004 at the origin (0, 0). In FIG. 10, the pixel 1004 is a pixel located out of the object area 1002 and its in-object area flag is “0”, and thus length calculation is not performed.

Next, whether a pixel (1, 0) on the right side of the pixel 1004 is in the object area is determined by using the in-object area flag for that pixel. The lengths are calculated and compared when such determination is repeated and it is determined that a pixel 1005 at the coordinates (2, 1) is located in the object area 1002 with its in-object area flag being “1”. More specifically, a first length from the coordinates (2, 1) of the pixel 1005 to the coordinates (0, 0) of the pixel 1004 at the upper left corner and a second length from the candidate for the position coordinates (7, 4) to the coordinates (0, 0) of the pixel 1004 at the upper left corner are calculated. The first length is calculated to be 2.23, and the second length is calculated to be 8.06, respectively, by using the Pythagorean theorem. Next, when the first length of 2.23 and the second length of 8.06 are compared, the first length is shorter than the second length, and thus the coordinates (2, 1) of the pixel 1005 are stored as a new candidate for the position coordinates. This embodiment overwrites the candidate for the position coordinates (7, 4) in the RAM 104 with the coordinates (2, 1).

Similarly, a pixel 1006 is located in the object area 1002, and thus the lengths are calculated and compared. The first length from the coordinates (3, 1) of the pixel 1006 to the coordinates (0, 0) at the upper left corner is calculated to be 3.16, and the second length from the candidate for the position coordinates (2, 1) to the coordinates (0, 0) at the upper left corner is calculated to be 2.23. As a result, since the second length is shorter than the first length, the candidate for the position coordinates is not overwritten.

The coordinates of a candidate for the position coordinates finally stored in the RAM 104 after the above processing is performed for all pixels in the determination image area 1001 are (2, 1) and correspond to a pixel closest to the pixel at the upper left corner among the pixels in the object area 1002. This embodiment uses the coordinates (2, 1) as the coordinates of the position of the parallelism information at the upper left corner and uses it for the subsequent processing. Similar processing is performed for the upper right position, lower left position, and lower right position, and the coordinates of the position of the parallelism information at these positions can be determined.

Next at step S607, the image processing unit 105 acquires (generates) the parallelism information at the position coordinates determined at step S606. The parallelism information is information as a guide for the user adjusting the tilt of the image pickup apparatus 100 so that the parallelism of the image sensor to the object becomes high. The parallelism information is acquired, for example, by acquiring the distance information at the position coordinates and calculating a difference between the distance from the imaging unit 107 to the object and a distance between the distance from the imaging unit 107 and the in-focus position, which are indicated by the distance information.

The parallelism information is not limited to acquisition from the distance information but may be acquired from the above information regarding defocus. Alternatively, an area may be defined based on the position coordinates, and the parallelism information may be acquired using a difference between averaged distance in the area and the distance to the in-focus position may be used as the distance information.

Next at step S608, the image processing unit 105 disposes the parallelism information acquired at step S607 at the position coordinates determined at step S606. More specifically, a superimposed image (second image) in which the highlighted image generated at step S603 and the parallelism display markers indicating the parallelism information are superimposed on the image is generated and output to the display unit 114.

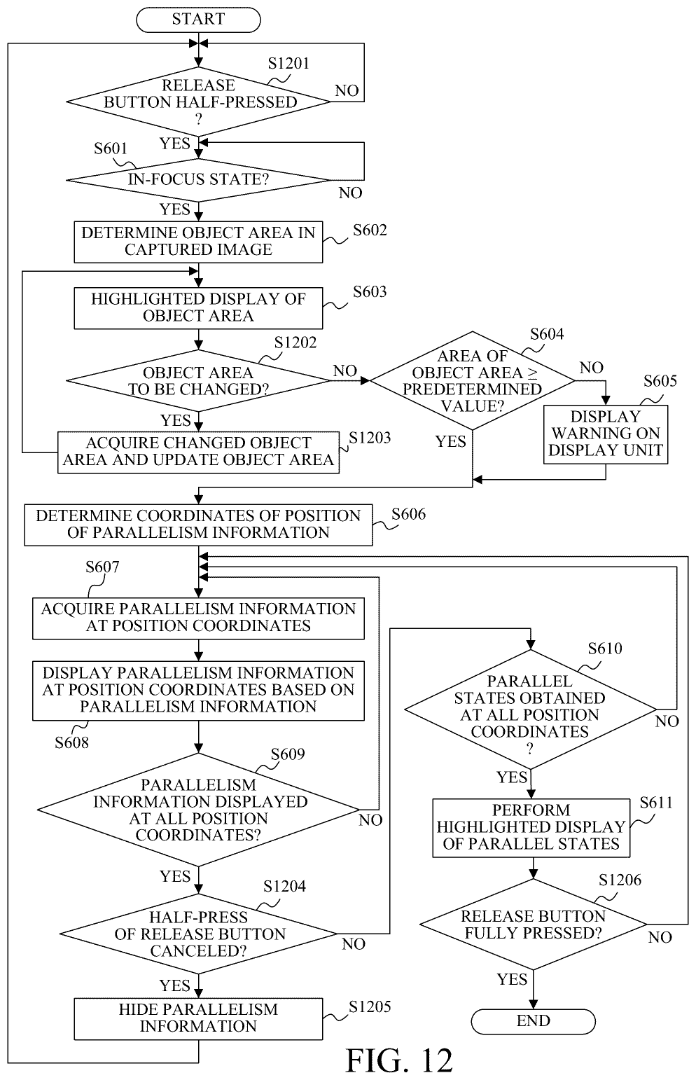

FIGS. 11A and 11B illustrate examples of parallelism display markers on a display unit 800 (114). FIG. 11A illustrates parallelism display markers 1101 indicating parallelisms to the object, at the upper left corner, upper right corner, lower left corner, and lower right corner on the highlighted image 803 indicating the object area in the image 801. FIG. 11B illustrates parallelism display markers 1102 and 1103 indicating nonparallel states to the object at the upper left, upper right, lower left, and lower right corners on the highlighted image 803.

This embodiment uses focus markers as the parallelism display markers. The focus marker display a focus state (defocus direction and in-focus state) on the object. In the in-focus state, a frame enclosing a focus target area and two triangles vertically facing each other so that their apexes coincide with each other are displayed as illustrated by each parallelism display marker 1101 in FIG. 11A. Thus, in a case where the parallelism display markers 1101 at the upper left corner, upper right corner, lower left corner, and lower right corner in the object area indicate the in-focus state, the user viewing the markers can know that the parallelism of the imaging unit 107 to the object is high (approximately parallel), in other words, the imaging unit 107 is properly or squarely facing the object.

In a front focus state in which a position closer than the object is focused, a frame enclosing a focus target area, two lower triangles having apexes pointed obliquely upward and outside, and one triangle having an apex pointed downward are displayed as illustrated by parallelism display markers 1102 in FIG. 11B. In a rear focus state in which a position farther than the object is focused, a frame enclosing a focus target area, two upper triangles having apexes pointed obliquely downward and inward, and one triangle having an apex pointed upward are displayed as illustrated by parallelism display markers 1103 in FIG. 11B. Thus, in a case where the upper left and upper right parallelism display markers 1102 indicate the front focus state and the lower left and lower right parallelism display markers 1103 indicate the rear focus state, the user viewing the markers can know that the imaging unit 107 is not properly facing the object. In this case, the user can know that the imaging unit 107 is tilted obliquely upward relative to the object.

A parallelism display marker different from the parallelism display markers illustrated in FIGS. 11A and 11B may be displayed. For example, parallelism display markers having different colors among the in-focus state, the front focus state, and the rear focus state may be displayed or parallelism display markers having different shapes from those of the parallelism display markers illustrated in FIGS. 11A and 11B may be displayed. Moreover, instead of indicating an in-focus state, the parallelism display markers may indicate a parallel or nonparallel state to the object, or may indicate a direction in which the tilt of the image pickup apparatus 100 is to be adjusted for parallelization.

FIG. 11C illustrates an example in which arrow symbols are used as parallelism display markers 1104 and 1105 that are different from the parallelism display markers 1101 to 1103 illustrated in FIGS. 11A and 11B. The upper left and upper right parallelism display markers 1104 indicate incoming arrow symbols toward the near side of FIG. 11C, and the lower left and lower right parallelism display markers 1105 indicate outgoing arrow symbols toward the far side of FIG. 11C. The user viewing the parallelism display markers 1104 and 1105 can know that the parallelization can be achieved by adjusting the tilt of the image pickup apparatus 100 so that the upper part of the imaging unit 107 moves to the near side and the lower part thereof moves to the far side.

The parallelism of the imaging unit 107 to the object may be displayed as a quantitative value. For example, FIG. 11D illustrates a shift distance from a parallel state (position parallel to the object) obtained from the distance information that is as a quantitative value, and shift distances at the upper left corner, upper right corner, lower left corner, and lower right corner of the object area in frames of parallelism display markers 1106. For example, the shift distance is positive when an object is located at a distance farther than the distance in the parallel state, and negative when the object is located at a distance closer than the distance in the parallel state.

The display positions of the parallelism display markers may be shifted from coordinates of the position of the parallelism information. For example, in FIG. 11B, the parallelism display markers 1102 partially overlap the outer rim line of the object area 802 (highlighted image 803), and the visibility of the parallelism display markers 1102 degrades. Accordingly, as illustrated in FIG. 11E, the display position of each parallelism display marker 1102 is offset from its position coordinates of the parallelism information by a predetermined amount so that the entire parallelism display markers 1102 can be displayed in the object area 802. Thereby, the visibility of the parallelism display markers 1102 can be prevented from degrading.

Next at step S609, the image processing unit 105 determines whether the parallelism information (parallelism display markers) is displayed at all coordinates of the positions of the parallelism information. In a case where the parallelism information is displayed at all position coordinates, processing at step S610 is performed. In a case where there are position coordinates of the parallelism information that have not yet been displayed, the flow returns to step S607 and the parallelism information is displayed at the position coordinates.

At step S610, the image processing unit 105 determines whether the parallelism information displayed at all position coordinates indicates the parallel state. In a case where the parallelization is achieved, processing at step S611 is performed. In a case where the parallelization has not yet been achieved, the flow returns to step S601 and repeats the above processing.

At step S611, the image processing unit 105 displays, in an highlighted manner on the display unit 800 (114), that the imaging unit 107 is parallel to the object. Thereafter, the flow returns to step S601 and repeats the above processing.

FIG. 11F illustrates an example of the highlighted display of the parallelism on the display unit 800 that colors the parallelism display markers 1101 at four locations, and superimposes the highlighted image 803 in a pattern different from the hatched pattern illustrated in FIG. 8 on the image 801. The user can easily check whether the imaging unit 107 is parallel to the object by viewing the colors of the parallelism display markers 1101 and change in the pattern of the highlighted image 803. In the highlighted display of the parallelism, parallelism display markers in different shapes from those of parallelism display markers in the nonparallel state may be displayed or the color of the highlighted image 803 may be different from that in the nonparallel state.

In this embodiment, the parallelism information is displayed at four positions of the upper left corner, upper right corner, lower left corner, and lower right corner in the object area, but another display method may be employed. For example, single parallelism information collectively indicating the parallelism information (such as the arrow symbols in FIG. 11C) at the upper-left, upper-right, lower-left, and lower-right corners in the object area may be displayed in the object area. Moreover, in this embodiment, an image on which the parallelism information is superimposed is displayed on the display unit 114 included in the image pickup apparatus 100. On the other hand, a video including information about the object area and the parallelism information may be output to the outside by using the video terminal 109 and the network module 108 illustrated in FIG. 1 or may be exported through the recording medium 112.

This embodiment can automatically determine an object area during servo AF and continuous AF, acquire distance information and the like within the object area, and display parallelism information. Thereby, the parallelization accuracy of the image sensor to the object by the user can be improved.

### Second Embodiment

A description will now be given of parallelism information display processing executed by the image pickup apparatus 100 (the CPU 102 and the image processing unit 105) during single AF according to a second embodiment. The single AF is a function to continuously fix a focus position even if the object moves after the release button is half-pressed by the user to focus on the object by AF.

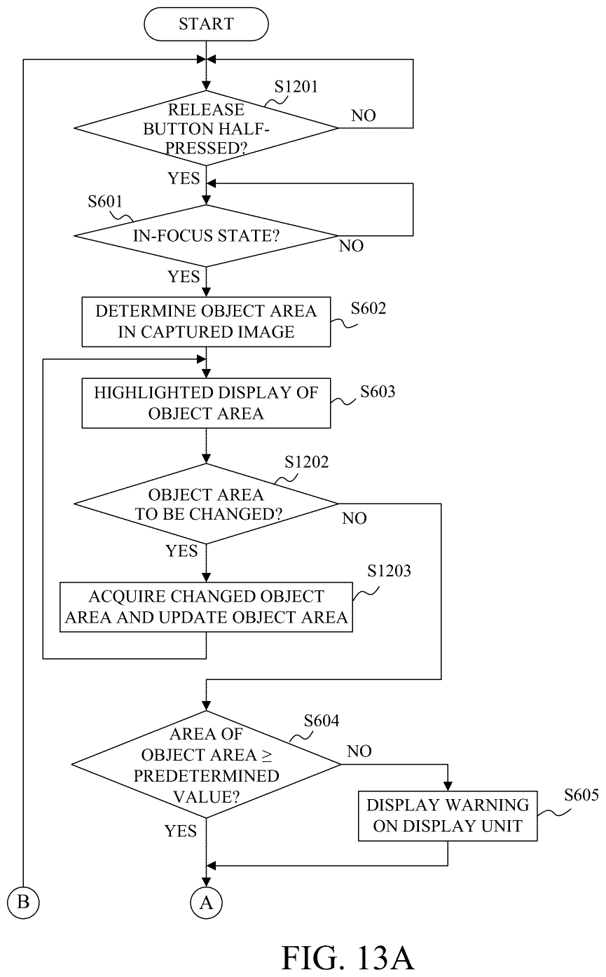

A flowchart of FIG. 12 illustrates superimposition display processing of parallelism information on an image that has been acquired through imaging by the image pickup apparatus 100 and displayed on the display unit 114. This processing is executed when a single AF mode is set to an AF mode through a setting menu by the user and imaging is started by the imaging unit 107. A step at which processing similar to that in the flowchart of FIG. 6 is performed among steps included in the flowchart of FIG. 12 is designated by the same step number as that of FIG. 6 and a description thereof will be omitted.

First at step S1201, the CPU 102 determines whether the release button of the operation unit 113 is half-pressed. In a case where the release button is half-pressed, processing at step S601 is performed. In a case where the release button is not half-pressed, the CPU 12 waits until the release button is half-pressed.

Processing at steps S601 to S603 is similar to that at steps S601 to S603 in FIG. 6.

At step S1202 after step S603, the image processing unit 105 determines whether the object area is to be changed. In a case where the object area is to be changed, processing at step S1203 is performed. In the case of no change, processing at step S604 is performed. The determination of whether the object area is to be changed is performed, for example, as the CPU 102 determines whether a change end switch provided at the operation unit 113 and operated by the user to end change in the object area has been operated. In a case where the change end switch has not yet been operated, change in the object area by the user is being performed and it is determined that the change is to be made. In a case where the change end switch has been operated, the change in the object area by the user has been completed or the change in the object area is not to be made, and it is determined that no change is needed. The determination of whether the object area needs to be changed is not limited to this method, but the determination may be performed based on whether an operation to change the object area is performed on the display unit 114 including a touch sensor as described below, or it may be determined that no change is needed when certain time has elapsed since an operation to change the object area is stopped.

At step S1203, the image processing unit 105 changes the object area based on an operation by the user. The object area is changed, for example, according to instruction to change the position of the outer rim line of the object area through a touch operation by the user on the display unit 114 including a touch sensor. Thereafter, the flow returns to step S603 and performs highlighted display of the changed object area.

Processing at steps S604 to S609 is similar to the processing at steps S604 to S609 in FIG. 6.

At step S1204 after step S609, the CPU 102 determines whether the half-press of the release button is canceled. In a case where the half-press is canceled, processing at step S1205 is performed. In a case where the half-press continues, processing at step S610 is performed.

At step S1205, the image processing unit 105 hides the parallelism information on the display unit 114. After the parallelism information is hidden, the flow returns to step S1201 and waits until the release button is half-pressed.

The processing at step S610 is similar to the processing at step S610 in FIG. 6. In a case where parallelism information displayed at all position coordinates indicates the nonparallel state to the object, the flow returns to step S602 to continue display determination of the parallelism information. In a case where the parallelism information displayed at all position coordinates indicates the parallel state to the object, processing at step S611 is performed.

Processing at step S611 is similar to the processing at step S611 in FIG. 6. After this processing, the CPU 102 performs processing at step S1206.

At step S1206, the CPU 102 determines whether the release button is fully pressed. In a case where the release button is fully pressed, this processing is ended. In a case where the release button is not fully pressed, the flow returns to step S602 to continue display determination of the parallelism information.

The CPU 102 may perform other processing when the parallelism information displayed at all position coordinates indicates the parallel state (in other words, it is determined that the image sensor is parallel to the object) and the release button is fully pressed. For example, the CPU 102 may cause the imaging unit 107 to perform imaging and record a captured image thus obtained in the recording medium 112. Accordingly, the user can perform imaging while maintaining the parallel state to the object by fully pressing the release button after checking the parallelism.

This embodiment can automatically determine an object area during the single AF, acquire distance information and the like within the object area, and display parallelism information. Thereby, the parallelization accuracy of the image sensor to the object by the user can be improved.

### Third Embodiment

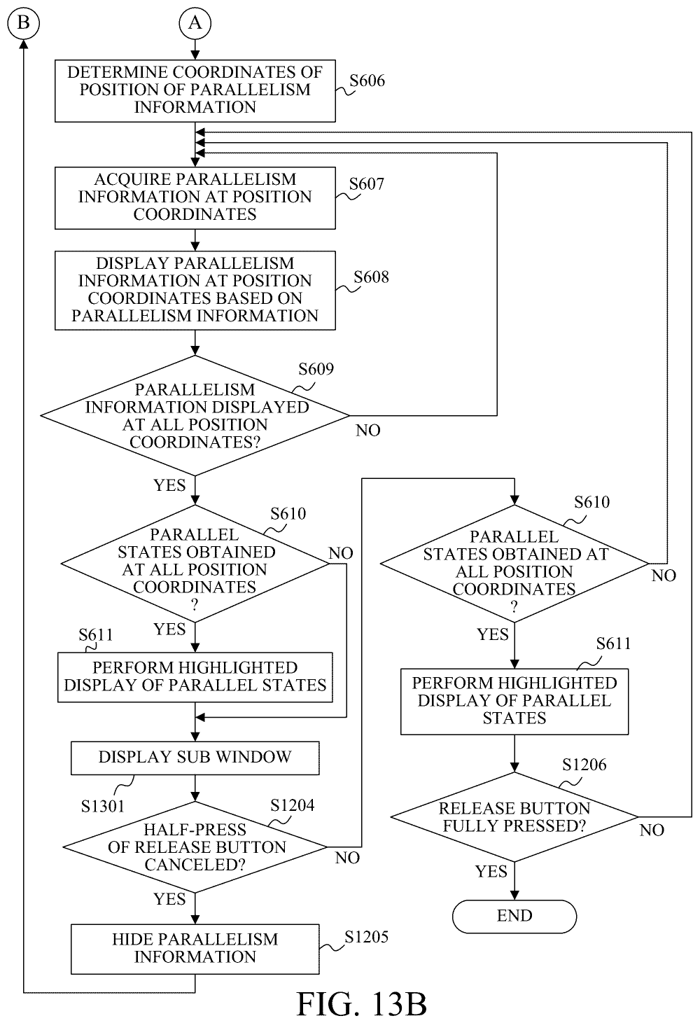

Referring now to FIGS. 13 to 15E, a description will be given of sub window display of parallelism information, which is executed by the image pickup apparatus 100 according to a third embodiment. This embodiment will describe sub window display of the parallelism information during the single AF as an example.

A flowchart illustrated in FIGS. 13A and 13B illustrates the sub window display processing of the parallelism information. This processing is executed when sub window display is set through a setting menu by the user and imaging is started by the imaging unit 107. A step at which processing similar to that in the flowcharts of FIGS. 6 and 12 is performed among steps included in the flowchart of FIGS. 13A and 13B is designated by the same step number as that of FIGS. 6 and 12 and a description thereof will be omitted.

Processing at steps S1201 to S1203 is similar to the processing at steps S1201 to S1203 in FIG. 12. Processing at steps S601 to S611 is similar to the processing at steps S601 to S611 in FIG. 6.

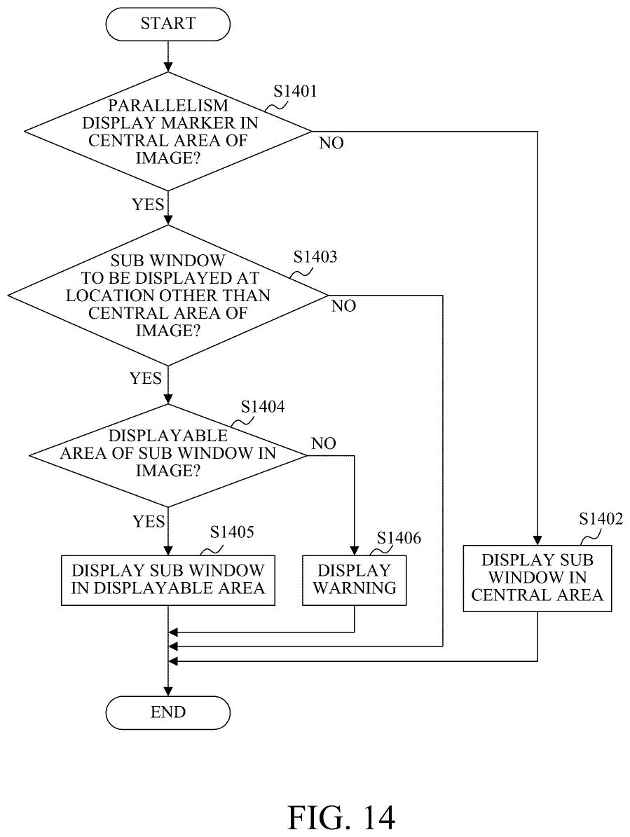

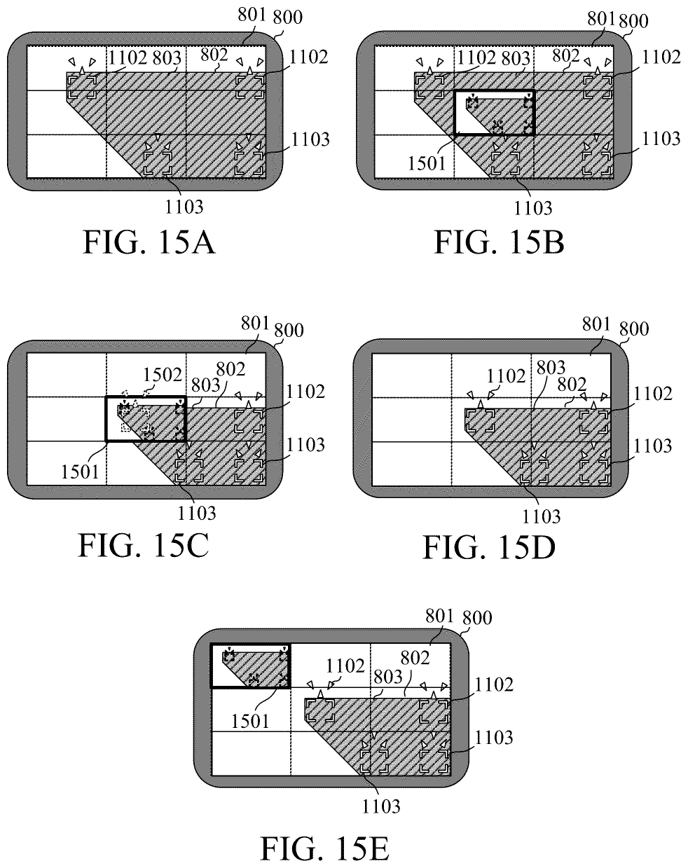

At step S1301 after step S611, the image processing unit 105 displays a sub window on the display unit 114. A flowchart of FIG. 14 illustrates processing for the image processing unit 105 to determine a display area of the sub window and perform sub window display. FIGS. 15A to 15E illustrate example displays on the display unit 800 (114) in this processing.

First at step S1401, the image processing unit 105 determines whether parallelism information display exists in a central area of an image. In a case where the parallelism information display exists in the central area, the image processing unit 105 performs processing at step S1403. In a case where no parallelism information display exists, the image processing unit 105 performs processing at step S1402. The determination of whether the parallelism information display exists in the central area of the image is performed, for example, by vertically and horizontally dividing the image 801 to set nine areas as illustrated in FIG. 15A and by determining whether the coordinates of the position of the parallelism information exist in the central area among the areas. Four lines in the image 801 in FIGS. 15A, 15B, 15C, 15D, and 15E are illustrated for description of the nine divided areas and do not have to be actually displayed on the display unit 800. The determination of whether the parallelism information display exists is not limited to this method, but the size of the central area may be changed, or whether the parallelism display markers 1101 to 1103 in FIG. 15A exist in the central area may be determined instead of the coordinates of the position of the parallelism information.

At step S1402, the image processing unit 105 displays a sub window 1501 in the central area in the image as illustrated in FIG. 15B. A superimposed image in which the highlighted image 803 and the parallelism display markers 1102 and 1103 are superimposed on the image 801 and that is scaled down to a size smaller than the image 801 is displayed in the sub window 1501. As illustrated in FIG. 15B, in a case where a ratio of the object area in the image 801 is large, the parallelism display markers 1102 and 1103 are displayed at positions close to ends of the image 801, and thus the user has difficulties in simultaneously checking the parallelism display markers 1102 and 1103. Thus, displaying the scaled-down image in the sub window 1501 enables the user to adjust the tilt of the image pickup apparatus 100 for the parallelization to the object only by checking the image in the sub window 1501.

An image displayed in the sub window is not limited to an image obtained by scaling down the superimposed image as described above. For example, the sub window may have transparency so that the image may be superimposed on the original superimposed image. Only the parallelism display markers may be displayed in the sub window. The colors and shapes of parallelism display markers may be changed to distinguish a parallelism display marker included in the original superimposed image from a parallelism display marker displayed in the sub window. Alternatively, the parallelism information superimposed on the original superimposed image may be hidden so that the parallelism information is displayed only in the sub window.

At step S1403, the image processing unit 105 determines whether to display a sub window at a location other than the central area in the image. In a case where a sub window is to be displayed at a location other than the central area, processing at step S1404 is performed. In a case where a sub window is not to be displayed, this processing is ended without displaying a sub window. The determination of whether to display a sub window at a location other than the central area is performed, for example, by determining whether setting to display a sub window at a location other than the central area is performed by the user through an operation on a setting menu.

At step S1404, the image processing unit 105 determines whether the image has a displayable area of a sub window. In a case where there is a displayable area of a sub window, processing at step S1405 is performed. In a case where there is no displayable area of a sub window, processing at step S1406 is performed. The determination of a displayable area of a sub window is performed, for example, by determining whether the parallelism information is displayed in each of the nine divided areas and by determining that a sub window can be displayed in the area in a case where no parallelism information is displayed.

As illustrated in FIG. 15C, in a case where the ratio that the object area 802 in the image 801 is small and the sub window 1501 is displayed, the sub window 1501 and a parallelism display marker 1502 potentially overlap each other and the visibility of the sub window 1501 may degrade. Thus, display is controlled according to results of the determination at steps S1403 and S1404 so that the sub window 1501 and the parallelism display marker 1502, which is not in sub window display, do no overlap each other.

At step S1405, the image processing unit 105 displays the sub window in the displayable area of the sub window determined at step S1404. Processing of displaying the sub window is similar to that at step S1402. In a case where there are a plurality of displayable areas of the sub window, the image processing unit 105 determines one sub window display area among the plurality of areas. For example, the display ability of the sub window is sequentially determined in the right direction with a starting point at the upper left area, and after the position reaches an area at the right end, the determination is performed in the right direction from an area at the left end on a row below. An area first determined to be a displayable area of the sub window is determined as a sub window display area.

In a case where the object area 802 is biased on the lower right side of the image 801 as illustrated in FIG. 15D, the upper left area is determined as a sub window display area. In this case, the sub window 1501 is displayed in the upper left area as illustrated in FIG. 15E.

The method of determining a sub window display area is not limited to this method, but for example, a displayable area of a sub window may be sequentially determined with a start point at an area other than the upper left area, or the display position of a sub window may be changed by the user. For example, a displayed sub window may be moved according to a touch operation on the display unit 114 including a touch sensor.

Processing at steps S1204 to S1206 after step S1301 is similar to the processing at steps S1204 to S1206 in FIG. 12.

This embodiment displays a sub window for parallelism information during the single AF, but a sub window for parallelism information may be displayed during servo AF and continuous AF. Sub window display can be achieved by, for example, performing processing at step S1301 described with reference to FIGS. 13A and 13B after step S609 in FIG. 6 described in first embodiment and thereafter returning to step S601 to repeat processing.

This embodiment can improve the visibility of parallelism information of the user by performing sub window display of parallelism information. Thus, this embodiment can further improve the parallelization accuracy of the image sensor to the object by the user.

In each embodiment, the image processing unit 105 as an information processing apparatus is built in the image pickup apparatus 100. However, a personal computer having functions similar to those of the image processing unit 105 (configured to operate according to a computer program that implements the similar functions) may be provided as an information processing apparatus separately from the image pickup apparatus. In this case, the information processing apparatus may determine an object area in and superimpose a highlighted image and parallelism information on an image acquired from the image pickup apparatus and may display a superimposed image on the display unit in the image pickup apparatus or an external monitor.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each embodiment can improve the parallelization accuracy of the image sensor to an object by acquiring first information specifically from the object area and by generating second information.

This application claims priority to Japanese Patent Application No. 2023-085676, which was filed on May 24, 2023, and which is hereby incorporated by reference herein in its entirety.

What is claimed is:

1. An information processing apparatus comprising:
a memory storing instructions; and
a processor configured to execute the instructions to:
determine an object area that includes an object in a first image obtained by imaging of the object through an optical system and an image sensor;
acquire, at a plurality of locations in the object area, first information that varies according to parallelism of the image sensor to the object;
generate second information as a guide for a user adjusting the parallelism according to the first information; and
output a second image including an image of the object area and the second information.

2. The information processing apparatus according to claim 1, wherein the processor disposes the second information at a position according to each of the plurality of locations in the second image.

3. The information processing apparatus according to claim 1, wherein the processor determines the object area using information regarding a distance from the image sensor obtained at a plurality of positions in the first image.

4. The information processing apparatus according to claim 1, wherein the first information is information regarding a focus state of the optical system on the object or information regarding a distance from the image sensor to the object.

5. The information processing apparatus according to claim 4,
wherein a plurality of pixels on the image sensor include a plurality of photoelectric conversion elements, respectively, the photoelectric conversion elements being configured to receive light from areas different from each other in a pupil of the optical system, and
wherein the processor acquires the first information using a phase difference between a pair of image signals generated by using signals output from the plurality of photoelectric conversion elements of the plurality of pixels.

6. The information processing apparatus according to claim 1, wherein the second information represents a defocus direction of the optical system relative to the object and an in-focus state of the optical system on the object.

7. The information processing apparatus according to claim 1, wherein the second information represents distances of the image sensor from positions parallel to the object at the plurality of locations.

8. The information processing apparatus according to claim 1, wherein the processor outputs the second image to a display unit configured to display an image.

9. The information processing apparatus according to claim 1, wherein the second image includes an image in which the object area is highlighted.

10. The information processing apparatus according to claim 1, wherein the processor determines a position at which the second information is disposed by using a length between a pixel in the object area and any of pixels at four corners of the first image.

11. The information processing apparatus according to claim 1, wherein the processor changes the object area according to a user operation.

12. The information processing apparatus according to claim 1, wherein the processor outputs a warning in a case where an area of the object area is smaller than a predetermined value.

13. The information processing apparatus according to claim 8, wherein the processor outputs the second information so that the second information is displayed in a sub window on the display unit.

14. The information processing apparatus according to claim 13, wherein the processor scales down and outputs the second image so that the second image is displayed in a sub window on the display unit.

15. The information processing apparatus according to claim 13, wherein the processor sets a sub window for display at a position that does not overlap the second information that is not displayed in the sub window.

16. An image pickup apparatus comprising:
the information processing apparatus according to claim 1; and
the image sensor.

17. The image pickup apparatus according to claim 16, wherein the processor uses autofocus to determine the object area.

18. The image pickup apparatus according to claim 16, wherein the image sensor captures the object according to a determination that the image sensor is parallel to the object based on the second information.

19. An information processing method comprising:
determining an object area that includes an object in a first image obtained by imaging of the object through an optical system and an image sensor;
acquiring, at a plurality of locations in the object area, first information that varies according to parallelism of the image sensor to the object;
generating second information as a guide for a user adjusting the parallelism according to the first information; and
outputting a second image including an image of the object area and the second information.

20. A non-transitory computer-readable storage medium storing a computer program configured to cause a computer to execute the information processing method according to claim 19.
